(19) United States
(12) Patent Application Publication
(10) Pub. No.: US 2022/0076589 A1
(43) Pub. Date: Mar. 10, 2022

(54) MATHEMATICS LEARNING GAME SYSTEM AND METHOD OF USING THE SAME

(71) Applicant: Mike HOWELL, Mesa, AZ (US)

(72) Inventor: Mike HOWELL, Mesa, AZ (US)

(21) Appl. No.: 17/466,653

(22) Filed: Sep. 3, 2021

Related U.S. Application Data
(60) Provisional application No. 63/074,612, filed on Sep. 4, 2020.

(51) Int. Cl. G09B 19/22; A63F 1/04; A63F 9/04; A63F 11/00

(52) U.S. Cl. CPC G09B 19/22; A63F 1/04; A63F 9/0415; A63F 2011/0076; A63F 2001/0416; A63F 2009/0446; A63F 11/0074

(57) ABSTRACT

Disclosed is a mathematics learning game system for users to improve upon their mathematics skills. Also disclosed is a method of using the system. The system may include cards, each having three color spots of different colors, and a random number in each color spot, a pair of 20-sided dice with the numbers 1 to 20, each side being of one of the colors of the color spots on the cards, and a timer device. A target number and target color are determined by rolling the dice. Players arrange cards to combine numbers of the target color from the cards into a mathematical expression with a solution as close as possible to the target number. Aspects of the present invention may be embodied as a system, method, or computer program product, such as an app that may operate on a computing device or network.

### CROSS REFERENCE TO RELATED APPLICATION[S]

This application claims priority to U.S. Provisional Patent Application Ser. No. 63/074,612, filed Sep. 4, 2020, the disclosure of which is hereby incorporated entirely herein by reference.

### BACKGROUND OF THE INVENTION

### Technical Field

This invention relates generally to educational games and particularly to a system and method for users to improve upon their mathematics skills.

### State of the Art

Mathematics, and particularly arithmetic, plays an important role in society. It is desirable for many people to become proficient in mathematics, and mental arithmetic in particular, for a great number of reasons. For many people, learning and practicing mathematics can be laborious and uninteresting. Accordingly, what is needed is an improved mathematics learning game system for improving mathematical skills, and mental arithmetic in particular, in an enjoyable competitive and interactive environment.

### SUMMARY OF THE INVENTION

The present invention relates to educational games and particularly to a system and method for users to improve upon their mathematics skills in an enjoyable competitive and interactive environment.

In some embodiments, the system comprises a deck of creature cards, wherein each creature card displays a unique figure, such as an image of an animal and a name corresponding to each unique figure. Also displayed on each creature card are three color spots of 3 different colors and a random number on each color spot. The system may also comprise a pair of 20-sided dice, wherein each side has a number from 1 to 20, and each side is of one of the three colors of the creature card color spots. The system may also comprise a timing device, such as a 1- or 2-minute sand timer, for example. The system may further comprise a plurality of arithmetic operator indicators, such as tokens, cards, dice, spinners, or the like, with corresponding plus signs, minus signs, multiplication signs, or division signs for indicating addition, subtraction, multiplication, and division, respectively.

A method of using the system, of the present invention, may comprise 2 or more players using the system according to a set of rules of game play. In a preferred embodiment, a set of rules of game play may be as follows: Each player holds a deck of creature cards facing down. Each player takes 3 cards from his or her respective deck and lays the 3 cards face up on a playing surface. A player rolls two 20-sided dice. The sum of the numbers rolled on the two dice is designated the “Target Number” and the color of the highest number rolled is designated the “Target Color”. A 1- or 2-minute sand timer may be started as soon as the Target Number and Target Color are determined.

Within the time allotted by the timer, each player arranges his or her cards in an order and combines each adjoining card by an arithmetic operator indicator, such as “plus”, “minus”, “times”, or “divided by”, wherein the number on the front face of each creature card displayed within the color spot of the color of the Target Color is used in combination with the corresponding arithmetic operator indicators to arrive at a non-negative whole number solution that is as close as possible to the Target Number. The player with the solution that is closest to the target number wins the round and claims the other players' cards in play. Successive rounds may continue until one player has claimed all the other player's cards to win the game, or, successive rounds may continue until each deck is played one time through, in which case the winner is the player with the most cards in the end.

Some embodiments of the system may comprise an app operating on a user computing device. In operation of the app, in response to selection by a user of a button for beginning a level of play, a game screen 12 is opened 3 creature card locations, each displaying creature cards in a rapid shuffle. Upon pressing a stop button, a target number and target color are displayed, and a timer begins to count down. The user arranges the order of the creature cards, using a number from each creature card in the color spot corresponding to the target color, in combination with selectable arithmetic operators between the cards, to arrive at a solution that is as close as possible to the target number. The app is programmed to determine the correct solution, and points are awarded for a user arriving at the correct solution.

In some embodiments, the system may include user computing devices and a computer server, wherein each user computing device is coupled to the server. The server may be programmed to process any programmable steps of the app described above, wherein the server performs certain steps in connection with other steps that are performed by the app on a mobile computing device. The server may aggregate game scores of various users of various user computing devices connected to the system for retrieval and display on a user computing device, a list of scores of the various users.

Use of the system fosters analytical thinking and improves mathematical skills, and mental arithmetic in particular, by requiring users to combine numbers into a mathematical expression that not only has a solution, but, as compared with other combinations with other solutions, is as close as possible to a target solution. This requires a higher level of analytical reasoning than simply resolving a mathematical expression into a solution. The system does so in a game environment with a time element and competition, making such improvement of mathematical skills enjoyable.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in conjunction with the Figures, wherein like reference numbers refer to similar items throughout the Figures, and:

FIG. 1 shows a home screen of a user interface of system for users to improve upon their mathematics skills, according to an embodiment;

FIG. 2 shows a game screen of a user interface of system for users to improve upon their mathematics skills, according to the embodiment of FIG. 1;

FIG. 3 shows a game screen of a user interface of system for users to improve upon their mathematics skills, according to the embodiment of FIG. 1;

FIG. 4 shows a game screen of a user interface of system for users to improve upon their mathematics skills, according to the embodiment of FIG. 1;

FIG. 5 shows a results screen of a user interface of system for users to improve upon their mathematics skills, according to the embodiment of FIG. 1;

FIG. 6 shows a game screen of a user interface of system for users to improve upon their mathematics skills, according to the embodiment of FIG. 1;

FIG. 7 shows a post score screen of a user interface of system for users to improve upon their mathematics skills, according to the embodiment of FIG. 1; and

FIG. 8 shows a leaderboard screen of a user interface of system for users to improve upon their mathematics skills, according to the embodiment of FIG. 1.

### DETAILED DESCRIPTION OF EMBODIMENTS OF THE INVENTION

As discussed above, embodiments of the present invention relate to educational games and particularly to a system and method for users to improve upon their mathematics skills.

In some embodiments, the system comprises one or more decks of creature cards, wherein each creature card comprises a front face and an opposed back face. For example, in a preferred embodiment, the system may comprise one or more decks of 30 creature cards. On the front face of each creature card may be displayed a unique figure, such as an image of an animal, for example, wherein each card displays a figure that is different from the figures of each of the other creature cards. In some embodiments, a name corresponding to each unique figure may also be displayed on the front face of each creature card, wherein each name is unique and corresponds to a unique figure. For example, one creature card may display an image of a jaguar and the corresponding name “JAG”, a second creature card may display an image of a lion and the corresponding name “LEO”, a third creature card may display an image of an eagle and the corresponding name “BALDO”, and so on. On the back face of each creature card may be displayed a back face display of any color, design, image, or the like, wherein the back face display of any creature card of the deck of creature cards is identical to the back face display of each of the other creature cards of the deck of creature cards. Each creature card, of the deck of creature cards, may be of any of a variety of contour shapes and any of a variety of sizes, without limitation, so long as all creature cards of the deck of creature cards are of the same contour shape and size.

Also displayed on the front face of each creature card is a plurality of color spots. Each color spot of the plurality of color spots may be of any of a variety of shapes, such as circular, square, square with rounded corners, and the like. Each color spot of the plurality of color spots may be of a unique color of a certain number of colors corresponding to the number of color spots on each creature card. For example, in a preferred embodiment, three color spots are displayed on the front face of each creature card and each of the three color spots is one of three different colors, each one of the three color spots being of a unique color that is different from each of the remaining color spots. As an example, a first color spot on the front face of each of the plurality of creature cards may be of a first color, a second color spot on the front face of each of the plurality of creature cards may be of a second color, and a third color spot on the front face of each of the plurality of creature cards may be of a third color. In an exemplary embodiment, the first color may be brown, the second color may be green, and the third color may be blue. However, this is not intended to be limiting. In general, the number of color spots on each creature card may be three, or it may be more or less than three, so long as the number of color spots on each creature card of the deck of creature cards is the same. Furthermore, the number of different colors of color spots should be the same as the number of color spots on each creature card, wherein each first color spot of each creature card is of a first color, each second color spot of each creature card is of a second color, and so on.

Within each color spot on each of the plurality of creature cards is displayed a randomized number or a set of numbers, such as a random whole number from 1 to 20, for example. It is possible that, among the total number of color spots of the plurality of creature cards, each number of the set of numbers may be displayed more than once, since the total number of color spots may exceed the total number of unique numbers of the set of numbers. For example, in an embodiment having a total of 30 creature cards, each creature card displaying 3 color spots (for a total of 90 color spots), and the set of numbers being the set of whole numbers from 1 to 20, each whole number of the set of whole numbers may be displayed 4 or 5 times.

In some embodiments, the front face of each creature card, of the plurality of creature cards, may comprise a border color, or background color, selected from the colors of the number of colors of the color spots. For example, in a preferred embodiment, the front face of each creature card has a border around its perimeter, wherein the color of the border is one of three colors of the colors of the 3 color spots. The color of the border color, or the background color, of the front face of any creature card is randomized, wherein the total number of creature cards having a border color or background color of a particular color of the colors of the color spots is substantially equal to the total number of creature cards having a border color or background color of another color. For example, in a deck of 30 creature cards, the total number of creature cards having a border color or background color of a first color may be 10, the total number of creature cards having a border color or background color of a second color may be 10, and the total number of creature cards having a border color or background color of a third color may be 10.

The system may further comprise a pair of dice, wherein each die of the pair of dice has a total number of sides corresponding to the total number of unique numbers of the set of numbers, each of the unique numbers being displayed on a side of the die. For example, in an embodiment wherein the set of numbers is the set of whole numbers from 1 to 20, the system may comprise a pair of 20-sided dice, wherein each whole number from 1 to 20 is displayed on a side of each of the pair of 20-sided dice.

In some embodiments, the system may further comprise a timing device, such as a sand timer. In some embodiments the sand timer may be a 1- or 2-minute sand timer, for example.

In some embodiments, the system may further comprise a plurality of arithmetic operator indicators for addition, subtraction, multiplication, and division. For example, without limitation, each indicator may be a token with a corresponding plus sign, minus sign, multiplication sign, or division sign. It is understood that any of a variety of arithmetic operator indicators may be used, such as tokens, cards, dice, spinners, or the like, so long as the indicator is configured to display an arithmetic operator.

A method of using the system, of the present invention, may comprise 2 or more players using the system according to a set of rules of game play. In a preferred embodiment, a set of rules of game play may be as follows: Each player, or two or more players, holds a deck of 30 creature cards with the front face of each of the 30 creature cards facing down, wherein the front face of each of the 30 creature cards displays three color spots. Each player takes 3 cards from his or her respective deck and lays the 3 cards face up on a playing surface. A player rolls two 20-sided dice. The sum of the numbers rolled on the two dice is designated the “Target Number” and the color of the highest number rolled is designated the “Target Color”. If the numbers rolled on each of the two dice is the same, and two colors of the three colors are rolled, then the “Target Color” is the color not rolled. A 1- or 2-minute sand timer may be started as soon as the Target Number and Target Color are determined.

Within the time allotted by the timer, each player arranges his or her cards in an order and combines each adjoining card by an arithmetic operator indicator, such as “plus”, “minus”, “times”, or “divided by”, wherein the number on the front face of each creature card displayed within the color spot of the color of the Target Color is used in combination with the corresponding arithmetic operator indicators to arrive at a non-negative whole number solution that is as close as possible to the Target Number.

As an example, for illustrative purposes only, in a round with 2 players, suppose that the Target Number is 15, the sum of a 7 and an 8 rolled on the dice, the Target Color is blue, the color of the side with the 8 rolled on the die, and the corresponding numbers displayed in the blue color spots of the first player's three cards played are 2, 8 and 10. Player 1 might arrange the three cards with the “plus” and “minus” operators as “8 plus 10 minus 2”, which equals a solution of 16. The solution of 16 is 1 whole number away from the Target Number of 15. The corresponding numbers displayed in the blue color spots of the second player's three cards played are 3, 4 and 7. Player 2 might arrange the three cards with the “times” and “minus” operators as “7 times 3 minus 4”, which equals a solution of 17. The solution of 17 is 2 whole numbers away from the Target Number of 15. Since player 1 arrived at a solution that is closer to the Target Number than the solution of player 2, player 1 wins the round. Player 1, as the winner of the round, will claim the three cards played by player 2. Successive rounds may continue until one player has claimed all the other player's cards to win the game, or, successive rounds may continue until each deck is played one time through, in which case the winner is the player with the most cards in the end.

Alternatively, in the example above, player 2 might have arranged his or her three cards with “plus” and “plus” operators as “7 plus 3 plus 4”, which equals a solution of 14. The solution of 14 is 1 whole number away from the Target Number of 15. Since both players arrived at solutions that are equidistant from the Target Number, the round ends in a tie. In the case of a tie, the played in that round remain in limbo, and subsequent tiebreaker rounds are played until a winner of all the cards in play and in limbo is determined.

It is contemplated that creature cards, of the present invention, may become collectible and tradeable. For example, children who frequently use the system may engage in collecting creature cards and trading them with their friends. Creature cards featuring certain figures may thereby become more or less rare or readily available in circulation and thus more or less valuable than others. Some creature cards may become more or less in demand than others for future game play.

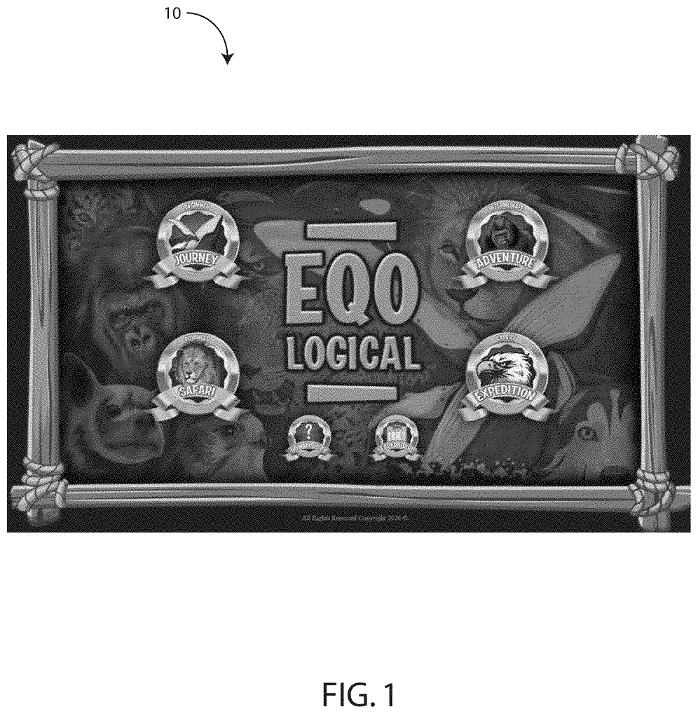

Some embodiments of the system may comprise an app operating on a user computing device having a user interface that displays a home screen 10 as shown in FIG. 1. The user computing device may be any of a desktop computer, a laptop, a tablet, a smartphone, a wearable device, or the like. The home screen 10 may include selectable soft buttons for a user to select various difficulty levels of play. For example, the home screen 10, as shown in FIG. 1, displays soft buttons labeled “JOURNEY”, “ADVENTURE”, “SAFARI”, and “EXPEDITION”, for beginning levels of play at difficulty levels of “BEGINNER”, “INTERMEDIATE”, “ADVANCED”, and “EXPERT”, respectively.

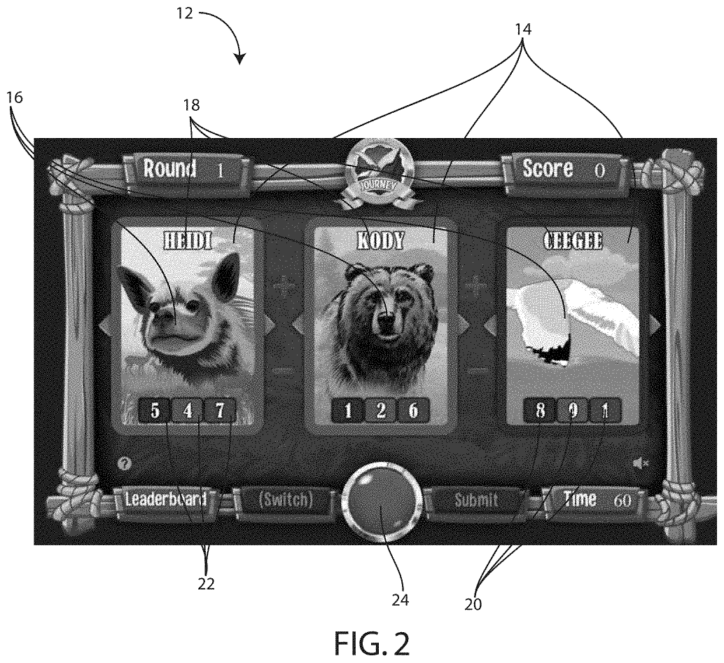

The app may include programming for storing creature card information for a predetermined number of creature cards corresponding to a deck of creature cards, as described more fully above. In response to selection by a user of a selectable soft button for beginning a level of play, a game screen 12 is opened, as shown in FIG. 2. The embodiment shown in FIG. 2 is a game screen 12 corresponding to the “JOURNEY” level of play of FIG. 1, opened in response to the user selecting the “JOURNEY” button on the home screen 10. Upon opening the game screen 12, creature cards 14, the respective FIGS. 16, names 18, numbers 20, and color spots 22 of which are drawn from the stored creature card information, are displayed in each of three creature card locations, each location rapidly shuffling through a plurality of creature cards 14 in rapid succession. The rapid shuffling of creature cards 14 in each card location continues until the user selects a stop button 24 displayed on the game screen 12.

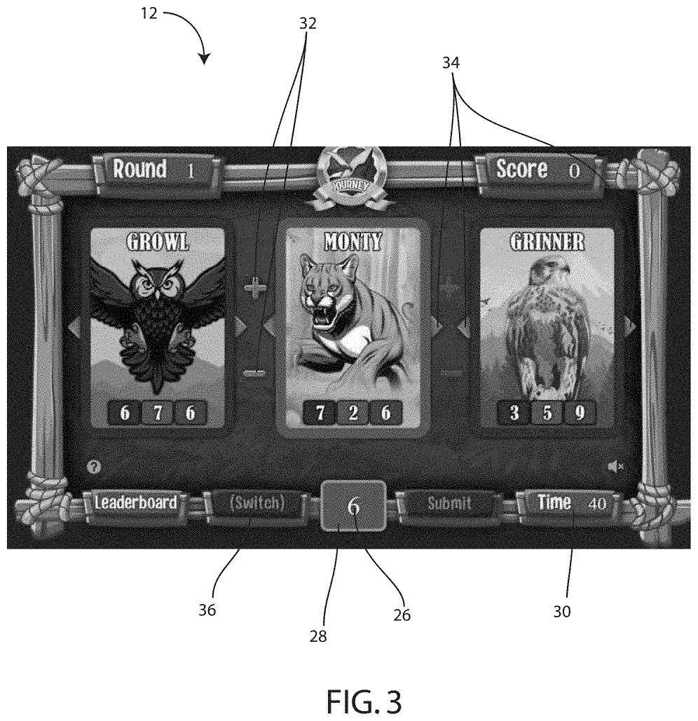

Upon pressing the stop button 24, a target number 26 and target color 28 are displayed, as shown in FIG. 3. The target number 26 is a random number selected by the app, and the target color 28 is a random selection by the app of one of the colors of the color spots 22 of the creature cards 14. Also, upon pressing of the stop button 24, a timer 30 is displayed, which counts down a predetermined number of seconds for game play of a first round of play, such as 60 seconds, for example.

Game play proceeds in a manner similar to game play of the method of using the system as described above, wherein the user arranges the order of the creature cards 14, using a number 20 from each creature card 14 in the color spot 22 corresponding to the target color 28, in combination with selectable arithmetic operators 32 between the cards, to arrive at a solution 42 that is as close as possible to the target number 28. As shown in FIG. 3, the game screen 12 displays arrows 34 at either side of each creature card, which are selectable for rearranging the order of the creature cards 14. For example, selecting a right arrow switches the creature card position with the adjacent creature card to the right. Selecting a left arrow switches the creature card position with the adjacent creature card to the left. In addition, the game screen 12 displays arithmetic operators 32 as selectable buttons between the creature cards 14. Furthermore, in some embodiments, the user may rearrange the order of operation of the arithmetic operators 32, such as by positioning a set of parentheses around either the first two numbers or the second two numbers. As an example, in the embodiment shown in FIG. 3, this may be done by a user selecting the Switch button 36.

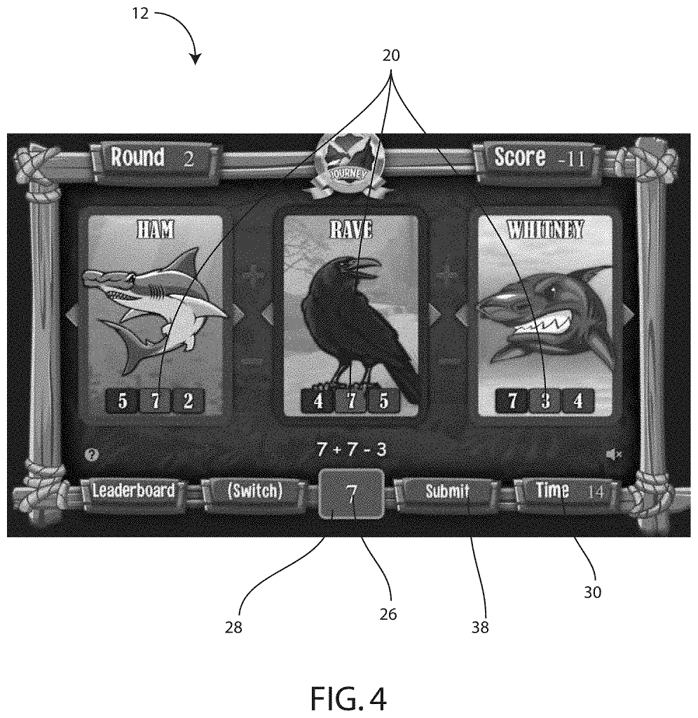

As an example, the game screen 12 of FIG. 4, displays a target number 26 of 7 and a target color 28 of brown. The numbers 20 to be used in play, from the color spots 22 on the creature cards 14 corresponding to the target color 28 of brown, are 7, from the first creature card, 7 from the second creature card, and 3 from the third creature card. The user may select the plus sign between the first and second creature cards and select the minus sign between the second and third cards, to form the expression “7+7−3”, which has a solution of 11. The user may then select the submit button 38 to stop the timer 30 and end the round. Selection of the submit button 38 is automatic when the timer 30 runs out.

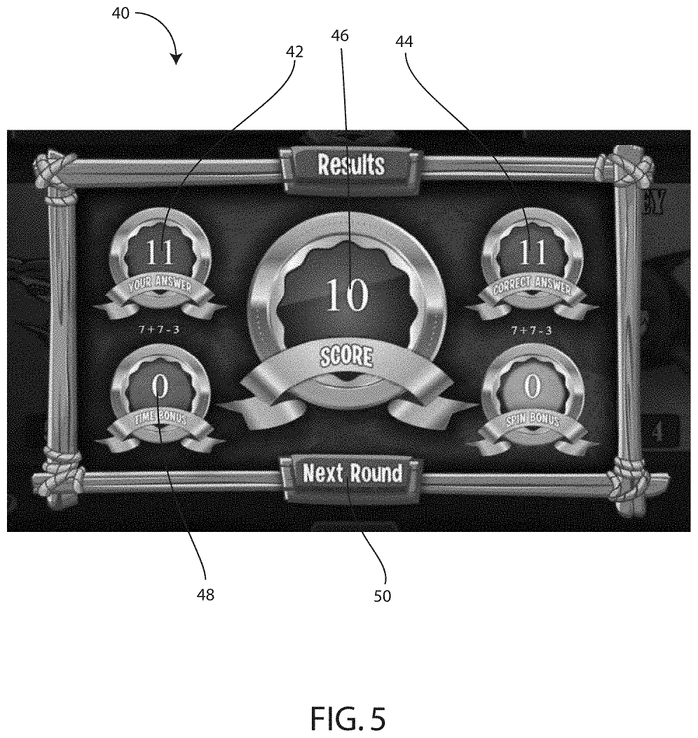

Upon selecting the submit button 38, the app displays a results screen 40, as shown in FIG. 5, showing the user's most recent solution 42, the correct answer 44, and the user's overall score 46. The app includes programming by which the correct answer 44 is selected as the combination of numbers 20 and arithmetic operators 32, of all possible combinations of the numbers and arithmetic operators in play, that is closest to the target number 26. In the example shown in the embodiment of FIG. 5, the correct answer 44 is shown as 11, which matches the user's solution 42 of 11. A predetermined number of points may be awarded to the user's score 46 for a solution 42 that matches the correct answer 44 and deducted for a solution 42 that does not match the correct answer 44. In some embodiments, points may also be awarded, shown as the time bonus of FIG. 5, for the number of seconds remaining on the timer 30 when the submit button 38 is selected, thereby incentivizing submission of a solution 42 as quickly as possible.

The player may then have an option to proceed to another round of play, such as by selecting a Next Round button 50, as shown in FIG. 5. Play may continue through a predetermined number of rounds, such as 10 rounds, for example, for a complete game, wherein the user's score 46 is cumulative of all rounds played in a complete game.

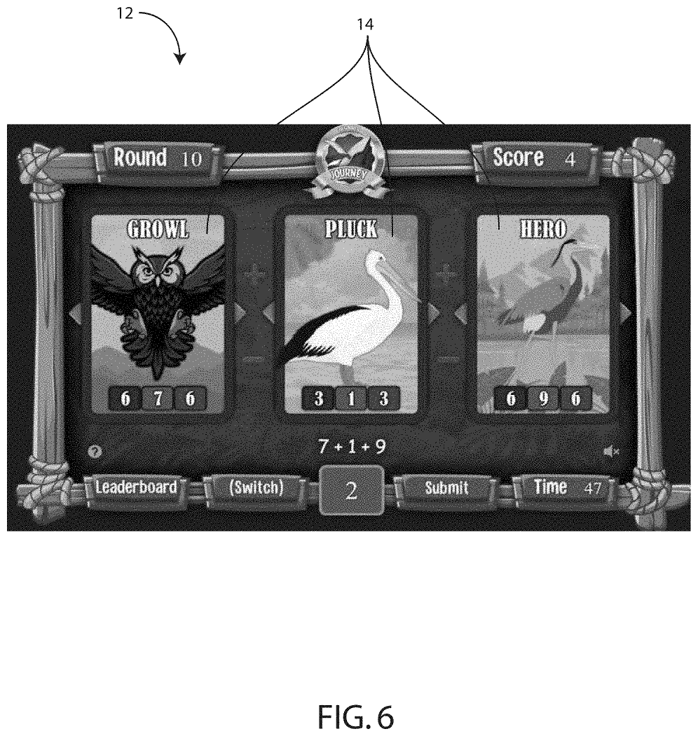

It may be possible, that when the user presses the stop button 24, the three randomized creature cards 14 displayed are of the same border or background color. For example, as shown in FIG. 6, all three creature cards 14 have a border color of blue. In some embodiments, a predetermined number of bonus points may be added to the user's score 46 in cases where pressing the stop button 24 results in a display of three creature cards 14 all of the same border or background color.

In some embodiments, the app includes programming, in response to selection of various levels of difficulty of play, on the home screen 10, to display game screens 12 for rounds of play at a variety of predetermined levels of difficulty of play. For example, more difficult levels of play may include higher numbers 20 and/or additional arithmetic operators 32 to choose from, whereas easier levels of play may include lower numbers 20 and/or fewer arithmetic operators 32 to choose from.

In some embodiments, the system may include a reward system to reward users for utilization of the system, such as through advertisements for business. The rewards may be coupons, discounts, or the like, or the rewards may be game play advantages for use of the system, such as bonus spins, bonus rounds, and the like for future use of the system.

In some embodiments, the system may include user computing devices and a computer server, wherein each user computing device is coupled to the server. This coupling may be a network connection, such as through an Internet connection, a Wi-Fi connection, a Bluetooth connection or the like, wherein the user computing devices may communicate with and receive communication from the server. The user computing device may be a desktop computer, a laptop, a tablet, a smartphone, or the like. The server, in some embodiments, may be a cloud-based infrastructure architecture.

The server may include a memory storing various data, including user data. The user data may include a user ID, and, in some embodiments, a password associated with each of various users that have logged into the server using a user computing device. The user computing device may be operating a mobile app as part of the system, wherein operation of the mobile app couples the user computing device to the server. The server may be programmed to receive a signal from the user computing device indicating the user computing device has connected to the server and containing a user ID of a user of the computing device in response to user input to the user computing device.

In some embodiments, the server may be programmed to process any programmable steps of the app described above, wherein the server performs certain steps in connection with other steps that are performed by the app on a mobile computing device. As may be applicable, certain programmable steps of the app described above may be processed on the server, wherein the server receives signals from the mobile computing device in response to user input to the user computing device and the server may send for display on the user computing device, displays of the various screens, including selectable soft buttons, as described in association with the app described above.

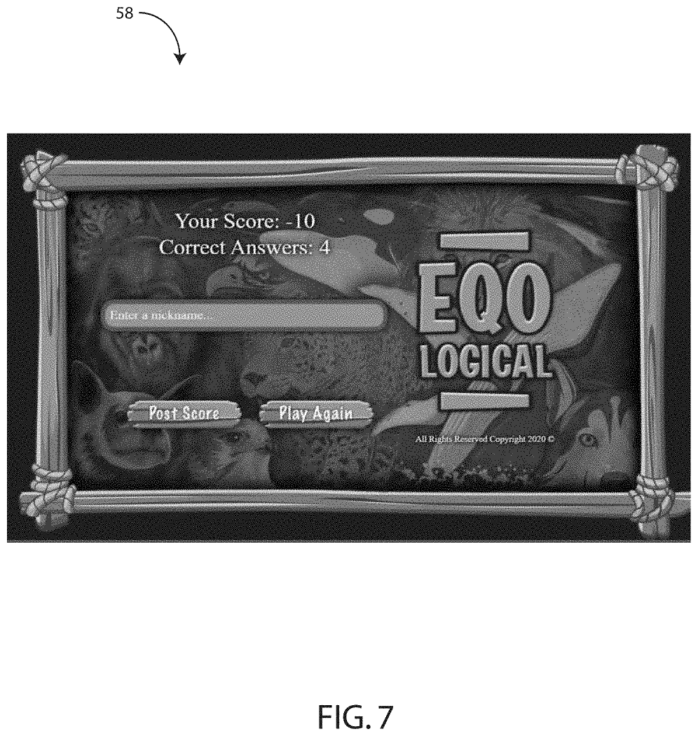

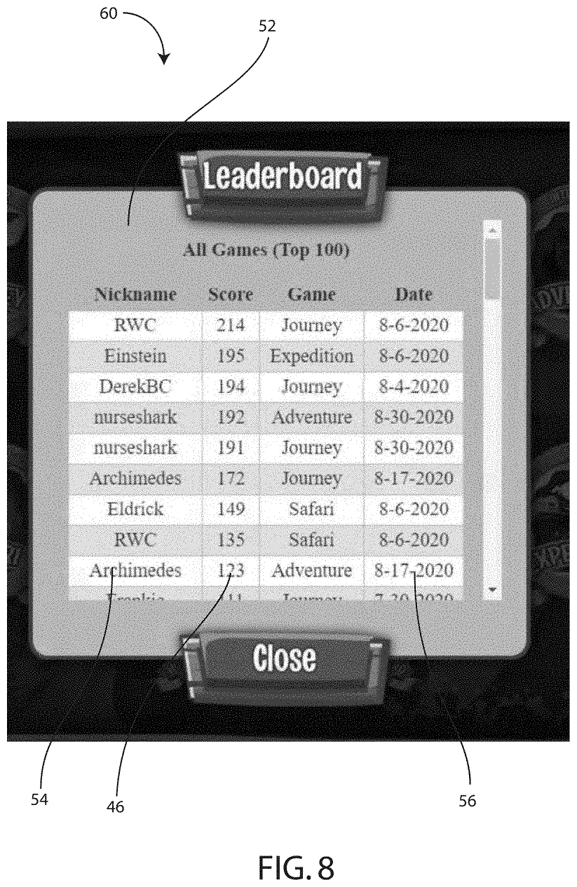

In some embodiments, the user data stored on the server may include game scores, dates and times of game play, associated with a user ID. Through the user interface, such as the post score screen 58, as shown in FIG. 7, a user may enter a user ID for storage on the server, wherein the server aggregates game scores of various users of various user computing devices connected to the system for retrieval and display on a user computing device, a list 52 of scores of the various users, as shown in FIG. 8. In some embodiments, as shown in the leaderboard screen 60 of FIG. 8, the list 52 of scores 46 may include a predetermined number of scores 46 of various users of the system, including the corresponding user IDs 54 and dates 56 on which those scores 46 were attained, sorted from highest score to lowest score.

It is understood that, just as in the physical system described above, the number of color spots 22 on each creature card 14 may be three, or it may be more or less than three, so long as the number of color spots 22 on each creature card 14 of the deck of creature cards 14 is the same. Furthermore, the number of different colors of color spots 22 should be the same as the number of color spots 22 on each creature card 14, wherein each first color spot of each creature card 14 is of a first color, each second color spot of each creature card 14 is of a second color, and so on. The number of color spots 22 on each creature card 14 will also correspond to the number of numbers 20 in play to form an expression during each round.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, apparatus (systems) and computer program products according to embodiments of the invention. It will be understood that, where applicable, each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A method of using a mathematics learning game system, the method comprising:
providing a mathematics learning game system comprising:
a deck of creature cards, wherein each creature card displays a unique figure, a name corresponding to each unique figure, and three color spots, each color spot having a different color and a random number on each color spot; and
two 20-sided dice, wherein each side has a number from 1 to 20, and each side is of one of three colors corresponding to the three colors spots of the creature card;
providing a portion of the deck of creature cards to each player of the game system, wherein the portion of the deck of creature cards are placed face down;
initiating a round by placing three cards from each portion of the deck of creature cards face up on a playing surface by each player;
rolling the two 20-sided dice, wherein a sum of the numbers rolled on the two dice is designated the “Target Number” and the color of the highest number rolled is designated the “Target Color”;
within a predetermined amount of time, arranging each of the three face up cards by each player in an order and combining each adjoining card by an arithmetic operator indicator, wherein the number on the front face of each creature card displayed within the color spot of the color of the Target Color is used in combination with the corresponding arithmetic operator indicators to arrive at a non-negative whole number solution that is as close as possible to the Target Number; and
designating a winner of the round as the player with the non-negative whole number solution that is closest to the Target Number.

2. The method of claim 1, further comprising claiming the three face up cards from the each player by the winner of the round.

3. The method of claim 2, further comprising continuing with successive rounds until one player has claimed all the cards of the deck of creature cards.

4. The method of claim 2, further comprising continuing with successive rounds until each card of each portion of the deck of creature cards for each player is placed face up one time, wherein a winner of the game is the player with the most cards.

5. A mathematics learning game system comprising:
a user computing device having a memory storing creature card information for a predetermined number of creature cards corresponding to a deck of creature cards and an application providing executable programmed instructions, wherein the user computing device is programmed to:
display a user interface in response to operating the application, the user interface displaying three creature cards in response to user input on the user computing device;
display on the user interface a randomly selected Target Number, a randomly selected Target Color, and a timer for a predetermined amount of time, the timer automatically initiating a count down for the predetermined amount of time in response to user input on the user computing device to initiate play of the mathematical learning game;
in response to user input on the user interface, arrange each of the three creature cards in an order and combine each adjoining creature card by an arithmetic operator indicator, wherein the number on the front face of each creature card displayed within the color spot of the color of the Target Color is used in combination with the corresponding arithmetic operator indicators to arrive at a non-negative whole number solution that is as close as possible to the Target Number; and
determine and display a score in response receiving user input to submit the non-negative whole number solution and comparing the submitted non-negative whole number solution with a stored correct solution.

6. The system of claim 5, wherein the score includes a predetermined number of points for a correct solution.

7. The system of claim 6, wherein the score includes a predetermined deduction of points for an incorrect solution.

8. The system of claim 7, wherein score includes a predetermined bonus amount of points for an amount of time remaining on the timer when the solution is submitted.

9. The system of claim 5, further comprising varying levels of difficulty of play.

10. A mathematics learning game system comprising:
a user computing device;
a server coupled to the user computing device, the server having a memory storing creature card information for a predetermined number of creature cards corresponding to a deck of creature cards, wherein the user computing device is programmed to:
receive a signal from the user computing device accessing the system and automatically send a user interface for display on the user computing device, the user interface displaying three creature cards;
receive a signal from the user computing device to initiate game play and automatically send for display on the user interface a randomly selected Target Number, a randomly selected Target Color, and a timer for a predetermined amount of time, the timer automatically initiating a count down for the predetermined amount of time;
in response to user input on the user interface on the user computing device, arrange each of the three creature cards in an order and combine each adjoining creature card by an arithmetic operator indicator, wherein the number on the front face of each creature card displayed within the color spot of the color of the Target Color is used in combination with the corresponding arithmetic operator indicators to arrive at a non-negative whole number solution that is as close as possible to the Target Number; and
determine and display a score in response receiving user input to submit the non-negative whole number solution and comparing the submitted non-negative whole number solution with a stored correct solution.

11. The system of claim 10, wherein the score includes a predetermined number of points for a correct solution.

12. The system of claim 11, wherein the score includes a predetermined deduction of points for an incorrect solution.

13. The system of claim 12, wherein score includes a predetermined bonus amount of points for an amount of time remaining on the timer when the solution is submitted.

14. The system of claim 10, further comprising varying levels of difficulty of play.
